(19) United States
(12) Patent Application Publication
(10) Pub. No.: US 2009/0240877 A1
(43) Pub. Date: Sep. 24, 2009

(54) VIRTUAL TAPE DEVICE AND METHOD FOR CONTROLLING THE SAME

(75) Inventor: Yukio TANIYAMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/404,825

(22) Filed: Mar. 16, 2009

(30) Foreign Application Priority Data
Mar. 19, 2008 (JP) 2008-071671

(51) Int. Cl. G06F 12/00

(52) U.S. Cl. 711/111; 711/E12.001; 718/100

(57) ABSTRACT

A virtual tape device in between a host and a library device is provided. The virtual tape device includes a physical tape volume and that stores data sent from the host on a logical tape volume includes, a receiver that receives a mount/unmount command and a job identifier relating to the command which are sent from the host, a storage device that stores the logical tape volume, a storage table that stores the job identifier and a logical tape volume to be accessed by a job indicated by the job identifier, and a controller that controls, based on the storage table, transfer of data relating to the job identifier between the logical tape volume and the physical tape volume.

### CROSS-REFERENCE TO RELATED APPLICATION(S)

This application is related to and claims priority to Japanese patent application no. 2008-071671 filed on Mar. 19, 2008 in the Japan Patent Office, and incorporated by reference herein.

### FIELD

The embodiments herein are directed to a virtual tape device and a method for controlling the virtual tape device.

### BACKGROUND

Conventionally, to back up data stored in a hard disk of a host device a library device has been used including a magazine that encloses a plurality of magnetic tapes, a drive that reads/writes data from/to the magnetic tapes, and a changer that moves the magnetic tapes between the magazine and the drive. With the library device, a huge amount of data can be stored by changing one magnetic tape for another. Furthermore, data can be reliably saved over a long period of time. However, access is gained to a magnetic tape at a lower speed than to a hard disk or the like. As the amount of data to be backed up has significantly increased due to the development of information systems, the slow access causes the backup process to take a long time to be performed, which may cause a problem in normal operation.

To address this problem, a virtual tape device that virtually emulates magnetic tapes on a hard disk that can be accessed at a high speed has conventionally been disclosed as being provided in between a host device and a library device (e.g., see Japanese Laid-Open Patent Application Publication Nos. 2006-139635 and 2000-20247, and Japanese Examined Patent Application Publication No. 7-97342).

FIG. 1 illustrates a conventional virtual tape device.

A virtual tape device 10 includes a virtual mount unit 11 that mounts/unmounts virtual tape volumes 13 in response to a command from a host device, a virtual read/write (R/W) unit 12 that performs read (R)/write (W) processing of data from/to the virtual tape volumes 13, the virtual tape volumes 13 obtained by virtually emulating multiple volumes among physical tape volumes 20 (e.g., magnetic tapes) on a hard disk, and a physical tape processor 14 that causes a library device in which the actual physical tape volumes 20 are mounted to perform mounting/unmounting of the physical tape volumes 20 and R/W processing of data. In the virtual tape device 10, part of a huge amount of data stored on the physical tape volumes 20 is stored on the virtual tape volumes 13 in increments of a volume. In response to an R/W process execution command from the host device, access is gained to the virtual tape volumes 13 prior to the physical tape volumes 20.

FIG. 2 illustrates a process including a series of operations performed conventionally in a virtual tape device.

In response to a command from the host device, the virtual mount unit 11 mounts the virtual tape volumes 13 (operation S1 in FIG. 2).

Thereafter, the virtual R/W unit 12 determines whether there exists, on the virtual tape volumes 13, target data to be read/written in response to the command from the host device. When the target data does not exist on the virtual tape volumes 13 (NO in operation S2 in FIG. 2), the physical tape processor 14 sends a command to the library device to read data in volumes including the target data from the physical tape volumes 20 and recover the data on the virtual tape volumes 13 (recall process performed in operation S3 in FIG. 2).

When it is determined that the target data exists on the virtual tape volumes 13, an notification indicating that R/W processing performed by the virtual R/W unit 12 on the virtual tape volumes 13 is enabled is sent (operation S4 in FIG. 2), and R/W processing of the virtual tape volumes 13 is performed (operation S5 in FIG. 2).

After the R/W processing is completed, the virtual mount unit 11 unmounts the virtual tape volumes 13 (operation S6 in FIG. 2), and the data that has been stored by the physical tape processor 14 on the virtual tape volumes 13 is transferred to and saved on the physical tape volumes 20 (migration performed in operation S7 in FIG. 2).

As above, with the virtual tape device, access is gained to the virtual tape volumes 13 prior to the physical tape volumes 20, and a recall process is performed only on data that does not exist on the virtual tape volumes 13. Therefore, access can be gained at a higher speed while leaving advantages of a known library device that can reliably store a large amount of data.

However, with the known virtual tape device, whether target data to be read/written exists on the virtual tape volumes is determined upon receipt of every command from the host device to mount the virtual tape volumes. When the target data does not exist on the virtual tape volumes, the target data is recovered from the physical tape volumes to the virtual tape volumes, and the read/written data is transferred from the virtual tape volumes to the physical tape volumes. Furthermore, even when items of data stored on the same physical tape volume may be successively read/written, a changer of the library device moves the same physical tape volume every time data is read/written, resulting in an increase in processing load.

### SUMMARY

It is an aspect of the embodiments discussed herein to provide a virtual tape device in between a host and a library device including a physical tape volume and that stores data sent from the host on a logical tape volume including a receiver that receives a mount/unmount command and a job identifier relating to the command, which are sent from the host, a storage device that stores the logical tape volume, a storage table that stores the job identifier and a logical tape volume to be accessed by a job indicated by the job identifier, and a controller that controls, based on the storage table, transfer of data relating to the job identifier between the logical tape volume and the physical tape volume.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a virtual tape device;

FIG. 2 illustrates operations performed in a conventional virtual tape device;

FIG. 3 illustrates a backup system to which an embodiment of a virtual tape device is applied;

FIG. 4 illustrates virtual tape device;

FIGS. 5A to 5C illustrate jobs that are set by a user using an operation computer;

FIG. 6 illustrates an exemplary a job execution time chart;

FIG. 7 illustrates an exemplary management table; and

FIG. 8 illustrates exemplary operations performed in the virtual tape device.

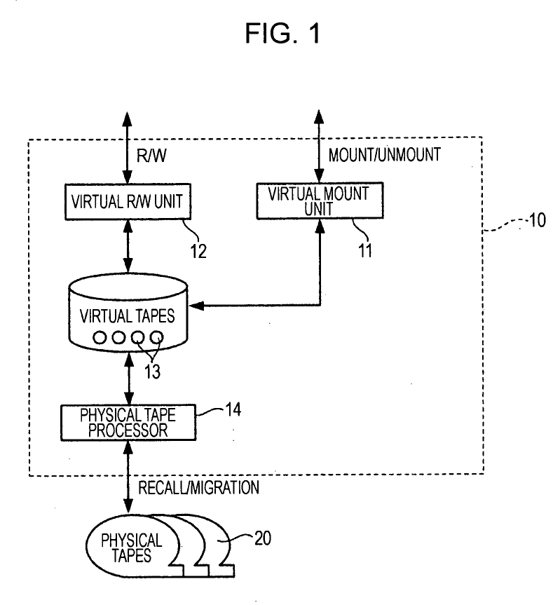

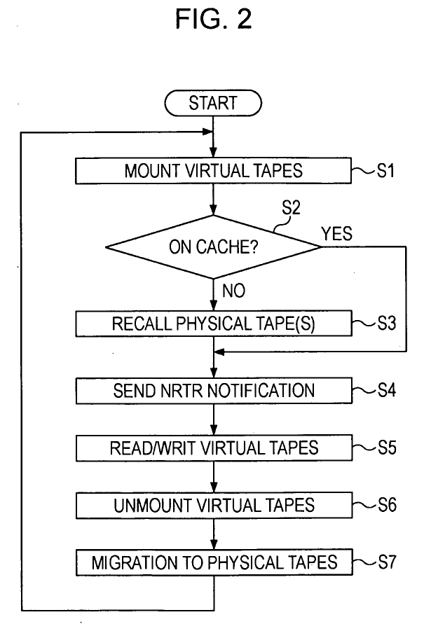

### DETAILED DESCRIPTION OF THE EMBODIMENTS

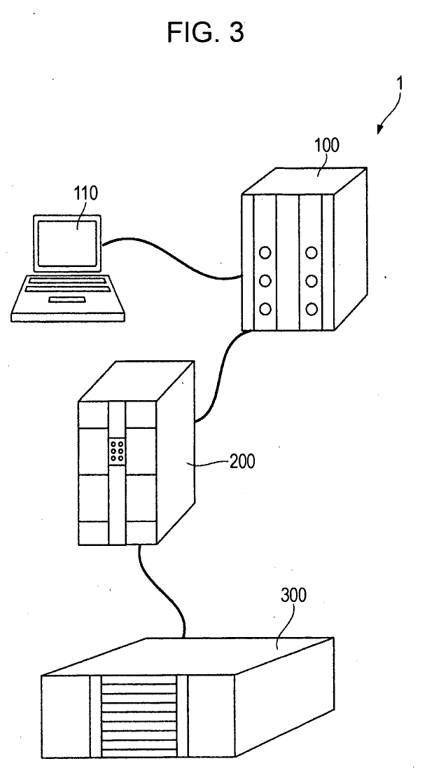

FIG. 3 illustrates a backup system 1 to which an exemplary embodiment of a virtual tape device is applied.

The backup system 1 illustrated in FIG. 3 includes a server device 100 to which an operation computer 110 is connected, a library device 300 including a plurality of magnetic tapes, and a virtual tape device 200 including a hard disk on which the magnetic tapes in the library device 300 may be virtually emulated.

The server device 100 is an exemplary host. In the server device 100, data stored on a built-in hard disk or a redundant arrays of inexpensive (independent) disks (RAID) device (not illustrated in the drawings) that may be externally connected to the server device 100 may be periodically backed up. In a backup process, a user can use the operation computer 110 to set the date on which a backup is executed (e.g., every Sunday at 17 o'clock) and a job name of a job for executing the backup, thereby a the generated schedule, the virtual tape device 200 is commanded to execute the job. When reference is made to old data that is not stored on the hard disk in the server device 100, the server device 100 sends a command to read the data to the virtual tape device 200.

The virtual tape device 200 is an exemplary virtual tape device and stores part of data stored in the library device 300 onto the hard disk which may be accessed at a high speed. In response to a data R/W command from the server device 100, access is gained to the virtual tape device 200 prior to the library device 300.

The library device 300 is a large-capacity storage device including a plurality of magnetic tapes and is an exemplary library device. The library device 300 includes a magazine that encloses a plurality of magnetic tapes, a drive that reads/writes data from/to the magnetic tapes, and a changer that moves the magnetic tapes between the magazine and the drive. The library device 300 performs R/W processing of the magnetic tapes in response to a command from the virtual tape device 200.

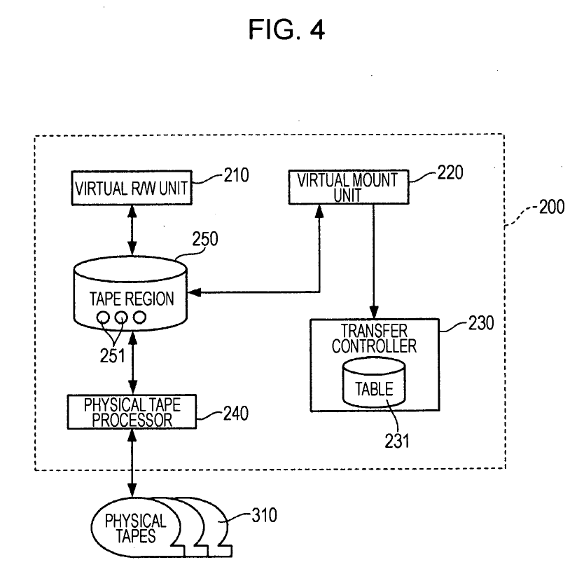

FIG. 4 illustrates an exemplary virtual tape device 200.

The virtual tape device 200 includes a tape region 250 obtained by emulating some of magnetic tapes 310 included in the library device 300 as virtual tape volumes 251 in increments of a volume. The tape region 250 is generated using the hard disk. The virtual tape device 200 includes a virtual mount unit 220 that mounts/unmounts the virtual tape volumes 251, a virtual R/W unit 210 that performs R/W processing of the virtual tape volumes 251, a transfer controller 230 that controls transfer of data between the virtual tape volumes 251 and the magnetic tapes 310, and a physical tape processor 240 that causes the library device 300 to perform mounting/unmounting of the magnetic tapes 310 and R/W processing of data. In an embodiment, tape names may be respectively given to the magnetic tapes 310. In the virtual tape device 200, the virtual tape volumes 251 with these tape names may be virtually generated in the tape region 250. The virtual tape volumes 251 are an exemplary logical tape volume. The magnetic tapes 310 are an exemplary physical tape volume. The virtual mount unit 220 is an exemplary receiver in the virtual tape device. The tape region 250 is an exemplary storage device in the virtual tape device. The transfer controller 230 is an exemplary controller in the virtual tape device.

Exemplary jobs set in the server device 100 are described.

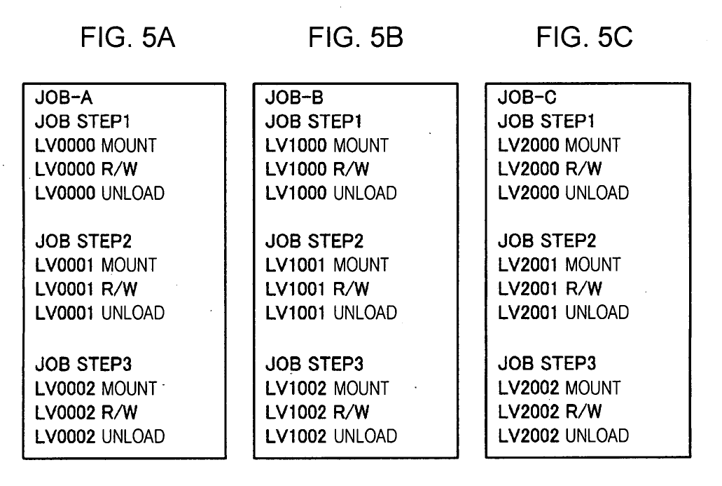

FIGS. 5A to 5C illustrate jobs that are set by a user using the operation computer 110.

In job A illustrated in FIG. 5A, it has been set to perform, as operation 1, mounting, R/W processing, and unloading of the virtual tape volume 251 with the tape name “LV0000”. It has been further set as operation 2 to perform mounting, R/W processing, and unloading of the virtual tape volume 251 with the tape name “LV0001”. It has been further set as operation 3 to perform mounting, R/W processing, and unloading of the virtual tape volume 251 with the tape name “LV0002”.

In job B illustrated in FIG. 5B, it has been set to perform, as operation 1, mounting, R/W processing, and unloading of the virtual tape volume 251 with the tape name “LV1000”. It has been further set as operation 2 to perform mounting, R/W processing, and unloading of the virtual tape volume 251 with the tape name “LV1001”. It has been further set as operation 3 to perform mounting, R/W processing, and unloading of the virtual tape volume 251 with the tape name “LV1002”.

In job C illustrated in FIG. 5C, it has been set to perform, as operation 1, mounting, R/W processing, and unloading of the virtual tape volume 251 with the tape name “LV2000”. It has been further set as operation 2 to perform mounting, R/W processing, and unloading of the virtual tape volume 251 with the tape name “LV2001”. It has been further set as operation 3 to perform mounting, R/W processing, and unloading of the virtual tape volume 251 with the tape name “LV2002”. In each of jobs A, B, and C, processing are sequentially done in the order of operations 1, 2, and 3.

The user sets, besides the details of the jobs illustrated in FIGS. 5A to 5C, the execution date of each job. In this example, the description assumes that job A illustrated in FIG. 5A is executed everyday at 12 o'clock; job B illustrated in FIG. 5B is executed every Saturday at 12 o'clock; and job C illustrated in FIG. 5C is executed on the first of every month at 12 o'clock. The server device 100 generates a job execution time chart in accordance with the execution date of each job set by the user.

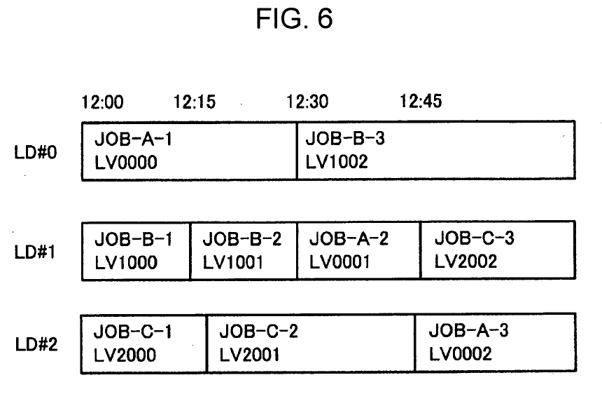

FIG. 6 illustrates a job execution time chart.

When jobs A, B, and C illustrated in FIGS. 5A to 5C are to be executed, if the first day of the month coincides with Saturday, commands to execute jobs A, B, and C are received at the same time. In the following description, a command to execute a job may be called a “mount command”. The server device 100 generates a time chart for processing jobs A, B, and C in parallel so that operations 1, 2, and 3 of each job are sequentially executed. In the example illustrated in FIG. 6, in the virtual tape device 200 and the library device 300, three processors (LD#0 to LD#2) can perform processing in parallel. That is, the first processor LD#0 executes operation 1 of job A and operation 3 of job B in this order. The second processor LD#1 executes operation 1 of job B, operation 2 of job B, operation 2 of job A, and operation 3 of job C in this order. The third processor LD#2 executes operation 1 of job C, operation 2 of job C, and operation 3 of job A in this order. In the virtual tape device 200 and the library device 300, the jobs are executed in accordance with the foregoing time chart.

The server device 100 sends the details of the jobs illustrated in FIGS. 5A to 5C as execution commands to the virtual tape device 200 in accordance with the job execution time chart.

The job execution commands sent from the server device 100 to the virtual tape device 200 are received at the virtual mount unit 220 illustrated in FIG. 4 and transferred to the transfer controller 230.

When the virtual tape device 200 and the library device 300 execute a job, the transfer controller 230 saves information regarding the job as a management table 231.

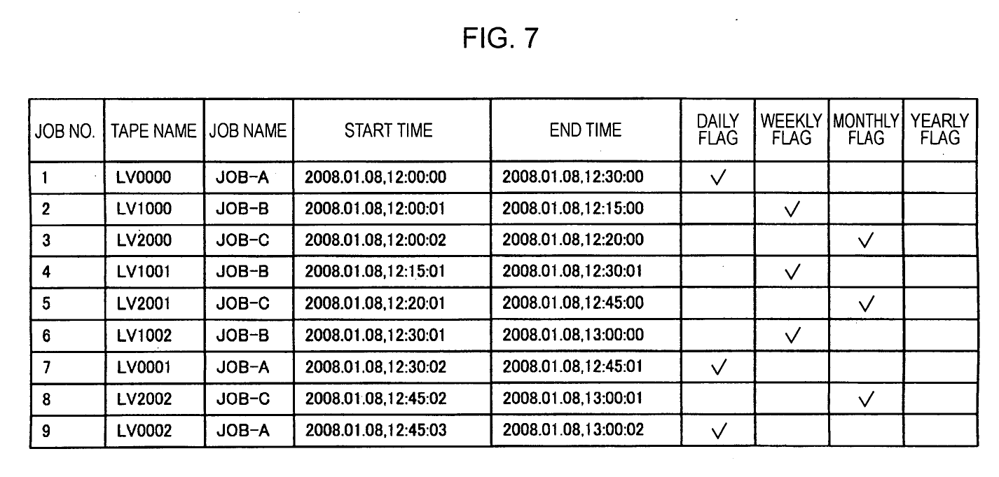

FIG. 7 illustrates management table 231.

The management table 231 includes a serial job number, a tape name (LV name), a job name, a job start date, a job end date, a daily flag, a weekly flag, a monthly flag, and a yearly flag. When a new job is executed in the virtual tape device 200 and the library device 300, the job name and the virtual tape volume number included in the job sent from the server device 100 (see, for example, FIGS. 5A to 5C) are registered in the management table 231 in increments of a operation. In addition, the start date and the end date of each operation are registered in the management table 231. When a job operation with the same job name and the same tape name has been registered in the management table 231, if the previous start date is one day ago, seven days ago, one month ago, or one year ago, the daily flag, the weekly flag, the monthly flag, or the yearly flag is set in the management table 231. The management table 231 is an exemplary storage table in the virtual tape device. The job name registered in the management table 231 is an exemplary job identifier in the virtual tape device. The daily flag, the weekly flag, the monthly flag, and the yearly flag correspond to examples of periodical information in the virtual tape device. In this embodiment, the previous job start date is registered in the management table 231. Since the next job start date may be easily predicted from this registered job start date and a corresponding flag, the management table 231 is equivalent to that in which the predicted next job start time is registered.

Exemplary R/W processing performed in the virtual tape device 200 is described.

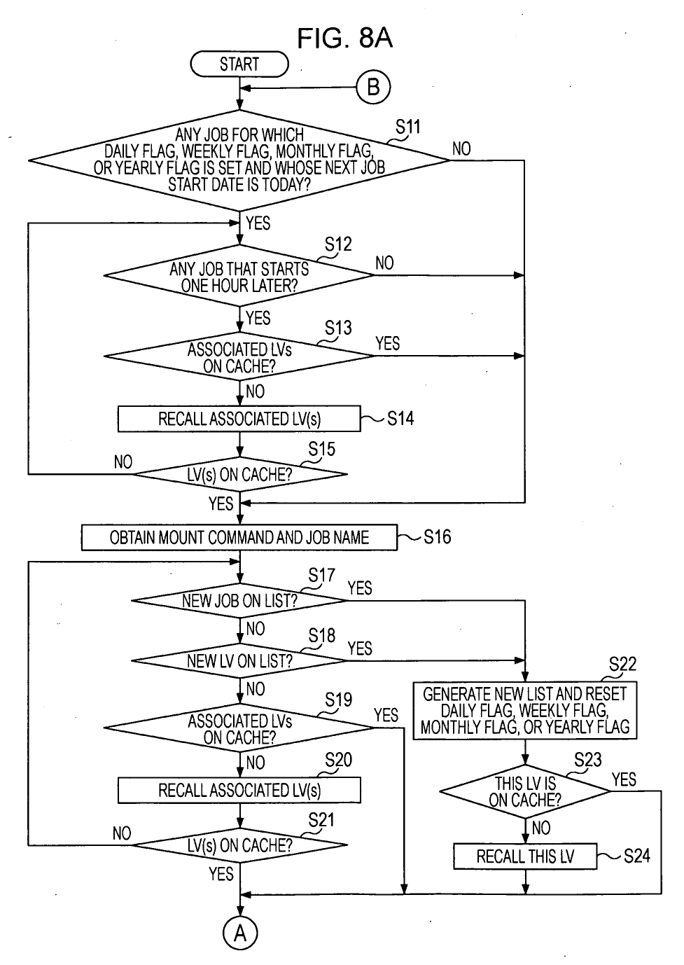

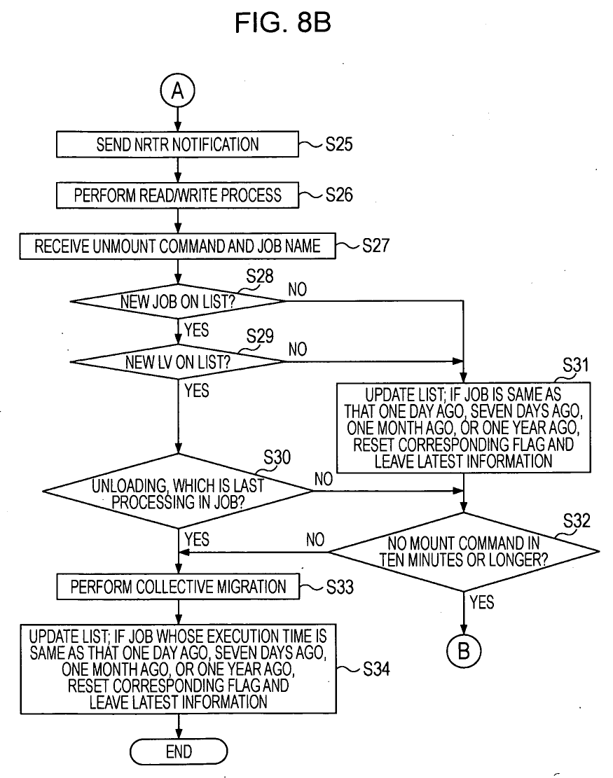

FIG. 8 illustrates a process including a series of operations performed in the virtual tape device 200.

The transfer controller 230 in the virtual tape device 200 determines whether there exists a job in the management table 231 illustrated in FIG. 7, for which the daily flag, the weekly flag, the monthly flag, or the yearly flag has been set, and whose next job start date predicted from the registered job start time and a corresponding flag is “today” (operation S11).

When a job to be executed today is registered in the management table 231 (YES in operation S11), it is further determined whether a job whose predicted next job start time is one hour later than the current time exists in the management table 231 (operation S12).

When a job that will start one hour later is registered in the management table 231 (YES in operation S12), all tape names (LV names) corresponding to the job name of that job are obtained, and it is determined whether the virtual tape volumes 251 associated with the obtained tape names exist in the tape region 250 (operation S13). For example, when a job with the job number “1” (operation 1 of job A) illustrated in FIG. 7 will start one hour later, all tape names “LV0000”, “LV0001”, and “LV0002” associated with jobs with the job numbers “1”, “7”, and “9” (operations 1, 2, and 3 of job A), respectively, which are associated with the job name “JOB-A”, are obtained, and it is determined whether all these virtual tape volumes 251 exist in the tape region 250.

When it is determined that not all the virtual tape volumes 251 exist in the tape region 250 (NO in operation S13), the physical tape processor 240 sends the tape name(s) of the missing virtual tape volume(s) 251 to the library device 300. As a result, among the magnetic tapes 310, data on the magnetic tape(s) 310 that is(are) given the sent tape name(s) is copied to the virtual tape device 200, thereby generating the virtual tape volume(s) 251 (recall process performed in operation S14). Furthermore, it is determined whether the data is stored on the generated virtual tape volume(s) 251 (operation S15).

As illustrated in FIG. 6, since the three processors (LD#0 to LD#2) can perform processing in parallel in the virtual tape device 200 and the library device 300, if a plurality of jobs that are to be executed at the same time exist, operations constituting these jobs are sequentially allocated to and executed by the three processors (LD#0 to LD#2).

With the foregoing processing, regarding a job that has already been registered in the management table 231, data is recovered from the magnetic tape(s) 310 to the virtual tape volume(s) 251 one hour before the next job start time.

When a job execution command including the details of a job illustrated in one of FIGS. 5A to 5C is actually sent from the server device 100, the job execution command is received at the virtual mount unit 220 and transferred to the transfer controller 230. Furthermore, the transfer controller 230 obtains the job name from the job which is illustrated in one of FIGS. 5A to 5C (operation S16).

The transfer controller 230 determines whether the obtained job name is a new job name that is not registered in the management table 231 illustrated in FIG. 7 (operation S17). Furthermore, the transfer controller 230 determines whether the tape name included in the job, which is illustrated in one of FIGS. 5A to 5C, is a new tape name that is different from tape names associated with the job name in the management table 231 (operation S18).

When both the job name and the tape name have already been registered in the management table 231 (NO in operation S17 and NO in operation S18), all tape names (LV names) associated with the job name of that job are obtained from the management table 231, and it is determined whether the virtual tape volumes 251 associated with the obtained tape names exist in the tape region 250 (operation S19). As has been described above, if a job has been registered in the management table 231, data is transferred to the virtual tape volumes 251 prior to sending of an execution command from the server device 100. Therefore, the processing speed may be increased. When a job registered in the management table 231, the scheduled execution time is known in advance. Therefore, if there exist a plurality of jobs that may be executed at the same time, operations including these jobs may be sequentially allocated in advance to the three processors (LD#0 to LD#2). Therefore, even when a plurality of job execution commands are sent, the jobs may be executed at the same time in the three processors (LD#0 to LD#2) in accordance with the time chart illustrated in FIG. 6. Therefore, the processing speed may be further increased.

When it is determined that not all the virtual tape volumes 251 exit in the tape region 250 (NO in operation S19), target data is recovered from the library device 300 to the virtual tape device 200 (recall process performed in operation S20). Furthermore, it is determined whether the target data is stored in the generated virtual tape volume(s) 251 (operation S21).

When a job whose execution command has been sent from the server device 100 is a new job that is not registered in the management table 231 (YES in operation S17 or YES in operation S18), the new job is registered in the management table 231 (operation S22). At this time, the daily flag, the weekly flag, the monthly flag, or the yearly flag of the new job is reset.

Thereafter, it may be determined whether the virtual tape volume 251 with the target tape name exists in the tape region 250 (operation S23). When this virtual tape volume 251 does not exist in the tape region 250 (NO in operation S23), the target data is recovered from the library device 300 to the virtual tape device 200 (recall process performed in operation S24).

When the target data is transferred to the virtual tape volume(s) 251 in the foregoing manner, an notification indicating that R/W processing performed by the virtual R/W unit 210 on the virtual tape volume(s) 251 is enabled is sent (operation S25), and R/W processing of the virtual tape volume(s) 251 is performed (operation S26).

When the R/W processing is completed, the virtual mount unit 220 unmounts the virtual tape volume(s) 251 of which R/W processing has been performed, and obtains the job name of the second job sent from the server device 100 (operation S27).

For the second job, as in operations S17 and S18, it may be determined whether the job name and the tape name of the job may be registered in the management table 231 (operation S28 and operation S29). When the job name and the tape name of the second job have already been registered in the management table 231 (NO in operation S28 or NO in operation S29), and when the previous job start date is one day ago, seven days ago, one month ago, or one year ago, the daily flag, the weekly flag, the monthly flag, or the yearly flag is updated to the latest information (operation S31).

When unloading which is the last processing in the job (YES in operation S30), in the management table 231 illustrated in FIG. 7, the R/W processing of a series of jobs given the same job name (e.g., operations 1, 2, and 3 of job A) has been entirely completed. Therefore, data stored on the virtual tape volumes 251 with the tape names (e.g., LV0000, LV0001, and LV0002) associated with these jobs is collectively transferred to and saved on the magnetic tapes 310 (migration performed in operation S33).

When the next mount command is not given in ten minutes or longer (NO in operation S32), a migration process is performed (operation S33). This migration process is performed because there may be the case where no execution command to access one or some of the virtual tape volumes 251 is sent due to a failure in the server device 100 or the like. According to an embodiment, a migration process is performed even when no mount command is given in a predetermined waiting time or longer. Therefore, data stored on the virtual tape volume(s) 251 of which R/W processing has been executed may be reliably stored on the magnetic tape(s) 310.

As above, according to an embodiment, data stored on magnetic tapes may be collectively recovered onto virtual tape volumes associated with the same job name. After the R/W processing is completed, data stored on the virtual tape volumes is collectively transferred to and saved on the magnetic tapes. Accordingly, the processing load may be alleviated, and the processing may be performed at a high speed. Because the execution cycle of a job is stored in the management table, data used in that job may be recovered in advance on virtual tape volumes before next execution of that job. Therefore, the processing speed may be significantly increased.

Although the foregoing describes use of magnetic tapes as physical tape volumes, the physical tape volumes may be optical storage media represented by, for example, magneto-optical (MO) disks, digital versatile disks (DVDs), and the like.

Although the foregoing describes an exemplary migration process performed when no mount command is given in ten minutes or longer, this waiting time may be variable, for example, according to the previous command reception intervals or the volume size.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A virtual tape device that is provided in between a host and a library device including a physical tape volume and that stores data sent from the host on a logical tape volume, the virtual tape device comprising:
a receiver that receives a mount/unmount command and a job identifier relating to the command, which are sent from the host;
a storage device that stores the logical tape volume;
a storage table that stores the job identifier and a logical tape volume to be accessed by a job indicated by the job identifier; and
a controller that controls, based on the storage table, transfer of data relating to the job identifier between the logical tape volume and the physical tape volume.

2. The virtual tape device according to claim 1, wherein the controller reads, based on the job identifier, entire data stored on a logical tape volume that does not exist in the storage device among logical tape volumes whose job identifiers are the same from the physical tape volume.

3. The virtual tape device according to claim 2, wherein a predicted start time of the job indicated by the job identifier is further stored in the storage table, and, entire data stored on a logical tape volume that does not exist in the storage device among logical tape volumes whose job identifiers are the same is read from the physical tape volume before the predicted start time.

4. The virtual tape device according to claim 3, wherein periodical information associated with each job identifier is stored in the storage table, and, entire data stored on a logical tape volume that does not exist in the storage device among logical tape volumes whose job identifiers are the same is read from the physical tape volume based on the periodical information.

5. The virtual tape device according to claim 1, wherein the controller writes entire data stored on logical tape volumes whose job identifiers are the same onto the physical tape volume after access to all the logical tape volumes whose job identifiers are the same is completed.

6. The virtual tape device according to claim 1, wherein the controller writes entire data stored on logical tape volumes whose job identifiers are the same onto the physical tape volume when no mount command for mounting the logical tape volumes whose job identifiers are the same is received in a predetermined time.

7. The virtual tape device according to claim 1, wherein, when the received job identifier does not exist in the storage table, the job identifier is added to the storage table.

8. A method for controlling a virtual tape device that is provided in between a host and a library device including a physical tape volume and that stores data sent from the host on a logical tape volume, the method comprising:
receiving a mount/unmount command and a job identifier relating to the command;
storing, in a storage table, the received job identifier and a logical tape volume to be accessed by a job indicated by the job identifier; and
controlling, based on the storage table, transfer of data relating to the job identifier between the logical tape volume and the physical tape volume.

9. The method according to claim 8, further comprising:
reading, based on the job identifier, entire data stored on a logical tape volume that does not exist in the storage device among logical tape volumes whose job identifiers are the same from the physical tape volume when controlling the data transfer.

10. The method according to claim 9, wherein a predicted start time of the job indicated by the job identifier is stored in the storage table, and,
entire data stored on a logical tape volume that does not exist in the storage device among logical tape volumes whose job identifiers are the same is read from the physical tape volume before the predicted start time.

11. The method according to claim 10, wherein periodical information associated with each job identifier is stored in the storage table, and, entire data stored on a logical tape volume that does not exist in the storage device among logical tape volumes whose job identifiers are the same is read from the physical tape volume based on the periodical information.

12. The method according to claim 8, wherein:
writing entire data stored on logical tape volumes whose job identifiers are the same onto the physical tape volume after access to all the logical tape volumes whose job identifiers are the same is completed when controlling the data transfer.

13. The method according to claim 8, wherein:
writing entire data stored on logical tape volumes whose job identifiers are the same onto the physical tape volume when no mount command for mounting the logical tape volumes whose job identifiers are the same is given in a predetermined time, when controlling the data transfer.

14. The method according to claim 8, wherein, when the received job identifier does not exist in the storage table, the job identifier is added to the storage table.
